(19) United States
(12) Patent Application Publication
(10) Pub. No.: US 2009/0121884 A1
(43) Pub. Date: May 14, 2009

(54) Tornado Alarm System

(76) Inventor: Pamela Lynn Harrell, (US)

Correspondence Address: PAMELA LYNN HARROLL, 5560 POINT WEST DRIVE, OAKWOOD, CA, 30566, US

(21) Appl. No.: 11/934,118

(22) Filed: Nov. 2, 2007

(51) Int. Cl. G01W 1/00

(52) U.S. Cl. 340/601

(57) ABSTRACT

This invention is a Tornado Alarm System designed to receive and respond to the National Weather Radio signals when a specific event indicating a tornado warning is issued for the county in which it is located. The device is approximately 4 inches by 6 inches by 2.5 inches in size and can be mounted on the wall or stand-alone on a table. It will set off a siren that can be heard anywhere inside a home, apartment, mobile home, office building, school or any building where the device is installed when the warning is received by the National Weather System.

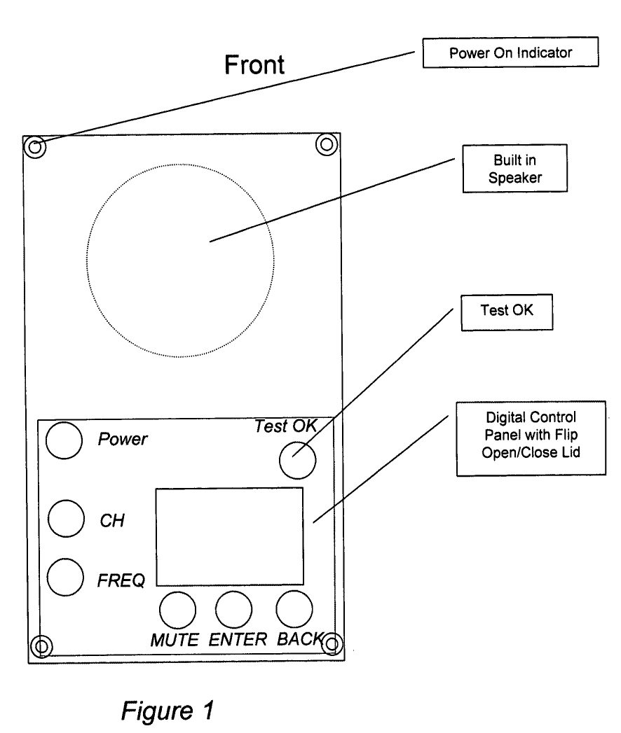

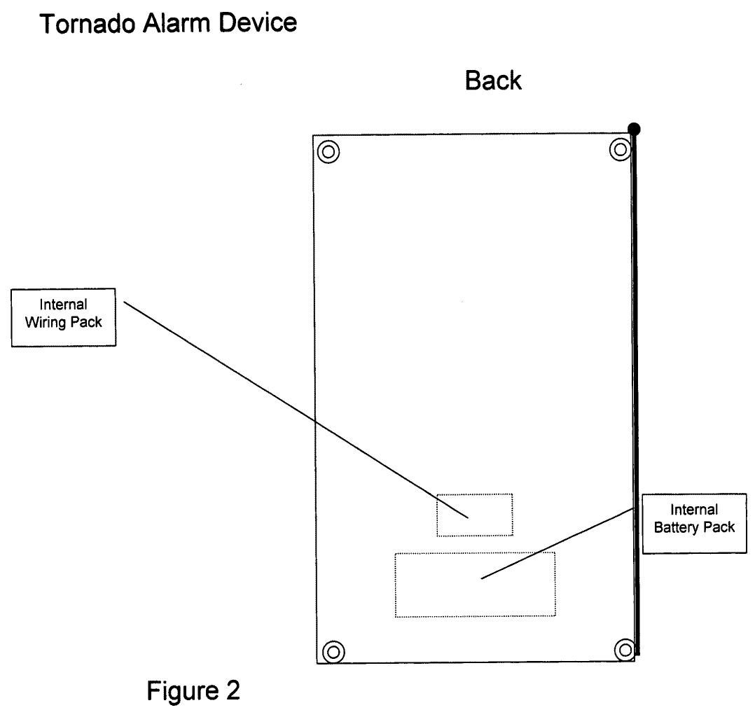

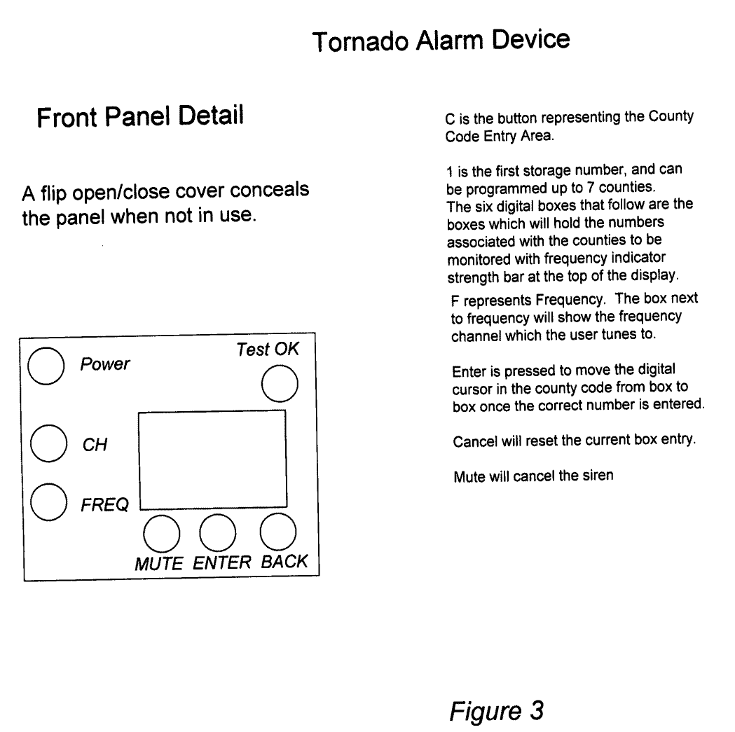

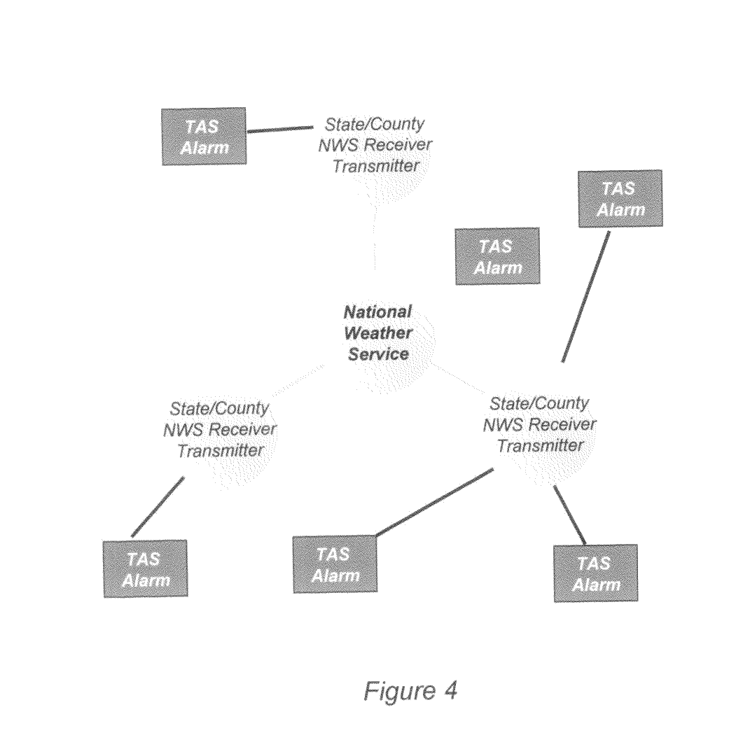

### REFERENCES CITED—U.S. PATENT DOCUMENTS

| | | |
|---|---|---|
| 4812825 | March 1989 | Kennedy, et al. |
| 5546800 | August 1996 | Daniel |
| 5781852 | July 1998 | Gropper |
| 5801636 | September 1998 | Tatom, et al. |
| 60189699 | January 2000 | Baron, Sr., et. al |
| 6034608 | March 2000 | Frank, et. al |
| 6125328 | September 2000 | Baron, et al |
| 6295001 | September 2001 | Barber |
| 6351218 | February 2002 | Smith |
| 7088254 | August 2006 | Liebenow |

### BACKGROUND OF THE INVENTION

This invention relates to the tornado warning codes that are issued through the VHF radio frequencies by the National Weather Service.

Tornados are a serious problem throughout the United States and cause extensive property damage and serious injury and death to citizens. While commercial tornado alarm devices are available to counties and cities in our country, they are typically strategically located near schools and larger populated areas. In some instances, the cost of the commercial alarm system is too expensive; therefore negating a system at all. When a warning triggers a commercial device, only individuals within a closer proximity of the siren will hear it. If it is during nighttime hours, and a person is asleep, the siren may not be heard at all.

This tornado device is designed to be thought of in similarity as once thinks of a smoke detector—small, loud, and mounted on a wall, or can sit on a flat surface. Its only function is to sound a siren to alert individuals, where the device is mounted, that a tornado warning has been issued. It is important for individuals to be alerted and have time to respond to a tornado warning by taking appropriate safety coverage. In many instances, the tornado warnings come during the night while an individual is sleeping. This device is designed to sound a siren with loud intensity such that it will awaken most individuals.

There have been many tornado warning systems developed with one of the most common being a weather radio. However, the disadvantage of the weather radio is the fact that the warning is a synthesized voice message that discontinues after three announcements; and is not specific to one event. Further, many individuals become desensitized over time to the multiple alert events and ultimately come to ignore the alerts and turn the device volume down or off. At that point, it becomes functionless. The weather radio is generally not suitable for mounting on the wall and does not have an aesthetic appearance. The tornado Alert System's only function is to monitor for the tornado warning alert code and sound a consistent loud audible siren—just as a smoke detector sounds an alarm when smoke is present. There is no confusion about the Tornado Alarm System's meaning or the need to act. The siren is a loud wobble sound specifically unique and different from a smoke detector's alarm.

### SUMMARY OF THE INVENTION

This tornado alarm device provides a method to detect and sound a siren to warn individuals that a tornado has been sited in the area. This device is designed to respond to the National Weather Service radio signals to events that indicate a tornado warning (or other severe “take action now” warning) and set off a siren inside the home, apartment, mobile home, office building, school or any building inside or outside where it is installed. Unlike a weather radio that broadcasts a synthesized voice for any weather change or alert, and for a broad area of service, this device is specific for a specific warning, and a specific county, and will set off a siren (similar to the way an alarm goes off on a smoke detector) when it receives the warning.

This tornado alarm device is a small device similar in size to a residential smoke detector or thermostat and is easily mounted on the wall. Once this device is mounted and the user interface is configured with the county codes, the device constantly monitors the National Weather Radio Service weather radio frequencies.

When the NWS transmits a tornado warning, the device will sound a siren. This siren is loud enough that it can wake most individuals from a sleep, thus giving them the opportunity to take proper action for protection.

### BRIEF DESCRIPTION OF THE DRAWINGS

Drawing A is the initial outside casing of the Tornado Alarm System. It is comprised of plastic parts, circuit boards, and antenna. A flap-hinged door when opened exposes an LED or GLASS display and the buttons to set the frequency and county codes programmable by the user.

Drawing B is a diagram that shows the flow from the National Weather Service to its receivers/transmitters and then to the Tornado Alarm System.

What is claimed is:

1. A tornado warning device that comprises a unit consisting of a VHF radio tuned to the National Weather Service (NWS) weather radio frequencies.

2. A tornado warning device that contains a digital decoder for decoding the NWS Specific Area Message Encoding (SAME) county and event codes.

3. A tornado warning device that contains an alarm circuit.

4. A tornado warning device of claim 3 that activates an audible siren alert.

5. A tornado warning device that has a user programmable interface circuit to select the frequency for the area of the device location.

6. A tornado warning device that contains a user programmable interface circuit to select the county code for the area of the device location.

7. A tornado warning device that monitors the weather radio frequencies of 162.40 to 162.550 MHz.

8. A tornado warning device that comprises a digital decoder for decoding the Specific Area Message Encoding for specific county and specific event codes.

9. A tornado warning device of claim 7 wherein the digital decoder is programmable for a specific event code, initially being a tornado warning.

10. A tornado warning device of claim 7 where the digital decoder is programmable to other specific event codes.

11. A tornado warning device of claim 7 where the digital decoder monitors and filters for the specific programmable code and weekly test issued by the NWS.

12. A tornado warning device that can be mounted on a wall while plugged into a 120V electrical power supply.

13. A tornado warning device that has a battery backup system built into the device.

14. A tornado warning device of claim 12 that can be hard wired in new construction.

15. A tornado warning device that retains in memory the programmed event, county and frequency if electrical power is lost.
